(19) United States
(12) Patent Application Publication
(10) Pub. No.: US 2014/0222654 A1
(43) Pub. Date: Aug. 7, 2014

(54) SYSTEM AND METHOD FOR PROVIDING ELECTRONIC CLOSING BOOKS TO CLIENTS AT COMPLETION OF SERVICES

(71) Applicant: Scott D. Griffin, Los Angeles, CA (US)

(72) Inventor: Scott D. Griffin, Los Angeles, CA (US)

(21) Appl. No.: 13/759,396

(22) Filed: Feb. 5, 2013

(51) Int. Cl. G06Q 10/00

(52) U.S. Cl. CPC G06Q 10/00
USPC 705/38; 705/343; 705/316

(57) ABSTRACT

The disclosure relates to a method of providing service to a client. The method entails providing the service to the client by a service provider; in the course of providing service to the client, generating a plurality of electronic documents related to the service; storing the plurality of electronic documents in a computer or network system associated with the service provider; transferring the electronic documents to a personalized electronic closing book; and providing the personalized electronic closing book to the client. The personalized electronic closing book may be provided to the client near or after completion of the service to the client. The personalized electronic closing book may include all or the most important documents related to the subject matter associated with the service provided to the client by the service provider. The personalized electronic closing book provides the client an organized and easily-accessible depository of documents generated at the end of a transaction.

### FIELD

This invention generally relates generally to services rendered to clients by service providers, and in particular, to a system and method for providing an electronic closing book to a client at completion of services rendered by a service provider, wherein the electronic closing book includes electronic documents relevant to the services provided to the client.

### BACKGROUND

Business transactions often require meticulous documentation of events. At the end of a business transaction, clients may be desire or be required to keep a set of documents generated during the transaction. Generally, paper copies are made and loosely placed in a notebook. These loose leaf notebooks are given to the client to keep for their records.

These notebooks may contain dozens of documents with hundreds of pages in various paper sizes such as letter, legal, and A4. For example, a real estate transaction may include government mandated disclosures, liens, statistical information about the neighborhood, photos of the property, etc. Other business transactions may require contracts, offers, letters of credit, letters of acceptance, assignments, etc.

These documents are often haphazardly organized or not organized at all, and simply placed in the binder according to the order in which they were signed. Finding a specific document may require manually shuffling through hundreds of pages of complex documents. To complicate matters, some of these documents may bear confusingly similar titles. For example multiple Addendums on California Association of Realtors (C.A.R.) form ADM look very similar but may contain different information.

What is needed is a device for storing and displaying all of the documents related to a business transaction in a searchable format. Said device would also serve to remind the client who were the principle agents of the transaction in case future contact was needed.

### SUMMARY

An aspect of the invention generally relates to an electronic book and more specifically to an electronic closing book for storing and presenting client documents regarding a specific transaction.

Electronic media readers or E-books display text and images on an electronic display. Some electronic readers use proprietary electrophoretic ink to display text. Others display text and images using a Liquid Crystal Display (LCD) or a Light Emitting Diode (LED) screen. Electronic readers equipped with networking technology are capable of browsing and downloading digitized books.

In one embodiment of the invention, the electronic closing book may be an electronic media reader preloaded with information related to a business transaction. The electronic media reader may be one of the numerous types commercially available. The electronic media reader may be a simple tablet capable of displaying text and rudimentary graphics or a high end portable computer.

Different price points of electronic media readers may be given to different clients depending on the value of the transaction. For example, a transaction involving multiple professionals and high dollar value may merit a higher end media reader. Lower profit transactions, conversely, may only merit a simpler media reader with limited functions and display quality.

In one embodiment, the electronic closing book may be a “thank you” book given at the end of a real estate transaction. The electronic closing book may be personalized with the client's name engraved on the electronic closing book or on a protective cover. Additionally, the electronic closing book may include engraving or other form of permanent markings, displaying the name and trademark of the real estate office or the client's business trademark.

The electronic closing book may store contact information of every professional involved in the transaction. The electronic closing book may also contain documents related to the real estate transaction.

Information stored on an electronic closing book may be stored in various non-transitory machine readable formats. Some examples of such include but is not limited to, any type of disk including floppy disks, optical disks, CD-ROMs, and magnetic-optical disks, read-only memories (ROMs), magnetic or optical cards, or any type of media suitable for long term storing of electronic instructions

The information stored in the electronic closing book may share a similar template across multiple electronic readers. Although the information displayed may look the same, depending on the electronic reader, the functionality of the templates may vary with the sophistication of the device. For example, certain electronic readers may offer a more sophisticated search function. Other electronic readers may be able to display video or play music.

Another aspect of the disclosure relates to a method of providing service to a client. The method entails providing the service to the client by a service provider; in the course of providing service to the client, generating a plurality of electronic documents related to the service; storing the plurality of electronic documents in a computer or network system associated with the service provider; transferring the electronic documents to a personalized electronic closing book; and providing the personalized electronic closing book to the client. The personalized electronic closing book may be provided to the client near or at completion of the service to the client. The personalized electronic closing book may include all or the most important documents related to the subject matter associated with the service provided to the client by the service provider. The personalized electronic closing book provides the client an organized and easily-accessible depository of documents related to the subject matter associated with the services rendered to the client by the service provider.

### BRIEF DESCRIPTION OF THE DRAWINGS

FIG. 1 illustrates a front view of an exemplary electronic closing book displaying an exemplary opening page in accordance with an aspect of the disclosure.

FIG. 2 illustrates a front view of the exemplary electronic closing book displaying an exemplary foreword page in accordance with another aspect of the disclosure.

FIG. 3 illustrates a front view of the exemplary electronic closing book displaying an exemplary transaction summary page in accordance with another aspect of the disclosure.

FIG. 4 illustrates a front view of the exemplary electronic closing book displaying an exemplary document navigation page in accordance with another aspect of the disclosure.

FIG. 5 illustrates a front view of the exemplary electronic closing book displaying an exemplary separation page in accordance with another aspect of the disclosure.

FIG. 6 illustrates a front view of the exemplary electronic closing book displaying an exemplary document access page in accordance with another aspect of the disclosure.

FIG. 7 illustrates a front view of the exemplary electronic closing book displaying an exemplary closing page in accordance with another aspect of the disclosure.

FIG. 8 illustrates a front view of the exemplary electronic closing book including an exemplary personalized cover in accordance with another aspect of the disclosure.

FIG. 9 illustrates a block diagram of an exemplary electronic closing book in accordance with another aspect of the disclosure.

FIG. 10 illustrates a block diagram of an exemplary system for personalizing an exemplary electronic closing book in accordance with another aspect of the disclosure.

FIG. 11 illustrates a flow diagram of an exemplary method of forming an exemplary electronic closing book in accordance with another aspect of the disclosure.

### DETAILED DESCRIPTION OF THE EXEMPLARY EMBODIMENTS

A method and an apparatus to provide an electronic closing book are described. In the following description, numerous specific details are set forth. However, it is understood that embodiments of the invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

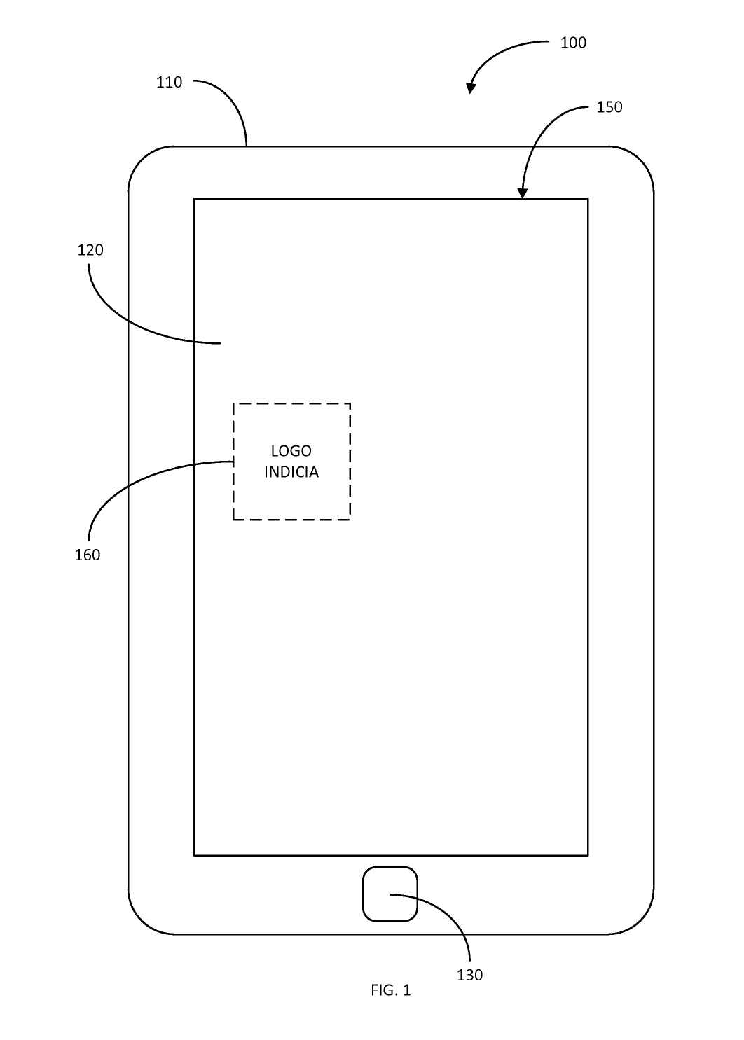

FIG. 1 illustrates a front view of an electronic closing book 100 displaying an exemplary opening page 150 in accordance with an aspect of the disclosure. The electronic closing book 100 may be an electronic media reader with a body 110 framing a display screen 120. Some functionality of the electronic closing book 100 may be controlled by function button 130. Alternatively, or in addition to, the display screen 120 may be a touch-sensitive display screen to allow a user to access available functions by way of touching the screen.

Body 110 may comprise a hard plastic, metal or composite. Body 110 is generally rectangular in shape with rounded edges and corners for comfortable handling. Body 110 generally has a flat reverse side (not depicted). Generally the front and back of body 110 are flat. Body 110 houses the electronic components of the electronic closing book 100.

The display screen 120 is flush mounted to the body 110 forming a uniformly smooth surface. Display screen 120 may use proprietary electrophoretic ink to display text. Display screen 120 may also be a Liquid Crystal Display (LCD) or a Light Emitting Diode (LED) screen. Display screen 120 may be used to display both text and graphic or even photos. For example, in FIG. 1, display screen 120 depicts the opening page 150, which includes an exemplary logo 160 associated, for example, with a service provider that provided the requested service to a client, who is to receive the electronic closing book at completion of the service.

As discussed above, the display screen 120 may also be tactile or touch responsive. A touch screen is an electronic visual display that can detect the presence and location of a touch within the display area. The term generally refers to touching the display of the device with a finger or hand. However, touch screens can also sense other objects, such as a stylus. Touch screens enable the user to interact directly with the display rather than indirectly through a pointer controlled by a mouse or trackball. Different embodiments of the invention may employ different types of touch screens technologies e.g. resistive, capacitive, infrared, optical imaging, acoustic pulse recognition. Navigating the electronic closing book 100 by touching the display screen 120 may enable more functionality as well as being more intuitive or user friendly.

Located on body 110 is function button 130. Function button 130 may be any shape and reasonable size. In FIG. 1, function button 130 is depicted as a roughly circular button. Function button 130 may also be raised above the surface forming a raised bump. Function button 130 may also be recessed below the surface of body 110 forming a slight depression. Function button 130 may turn the electronic closing book 100 from a powered off state to a powered on state. Once powered on function button 130 may be used to actuate other functions of the electronic closing book 130. For example, function button 130 may be used to control a mouse pointer by pressing the edges of function button 130 in the direction desired.

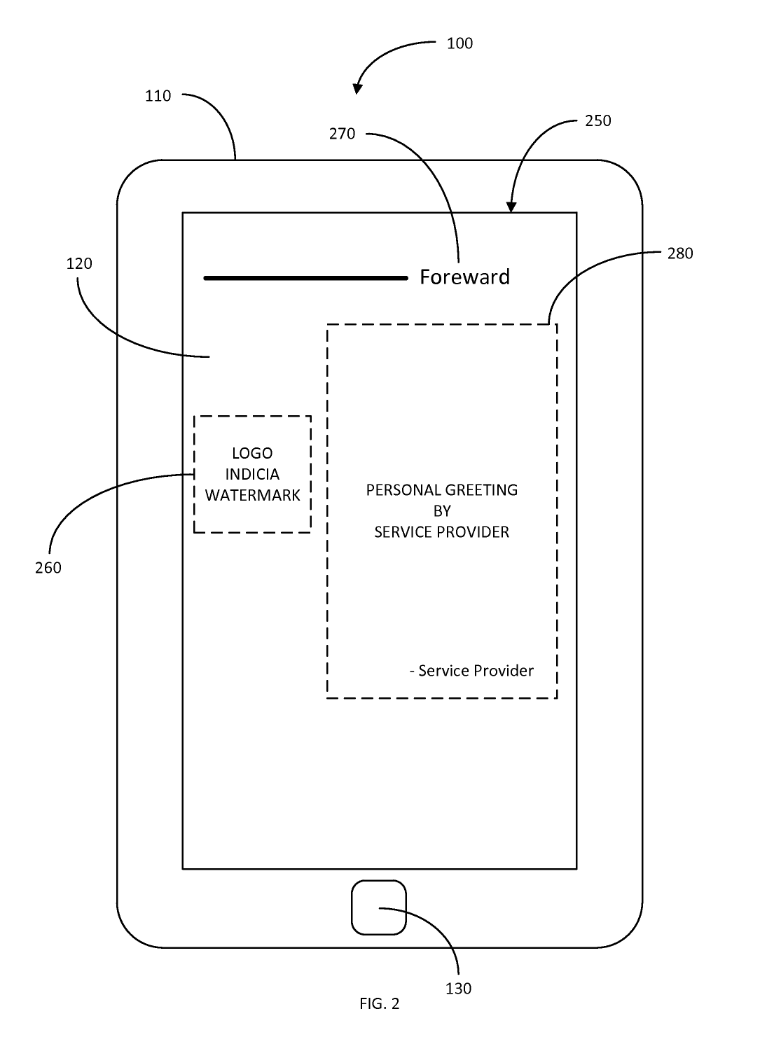

FIG. 2 illustrates a front view of the exemplary electronic closing book 100 displaying an exemplary foreword page 250 in accordance with another aspect of the disclosure. The foreword page 250 may include a page heading 270 identifying the page for providing foreword or opening remarks. The forward page 250 further comprises a personal greeting section 280 that provides a personal greeting to the client by service provider, as well as an introduction to the capabilities of the electronic closing book 100. The foreword page 250 may also include a watermark 260 which may be the logo or trademark of the service provider.

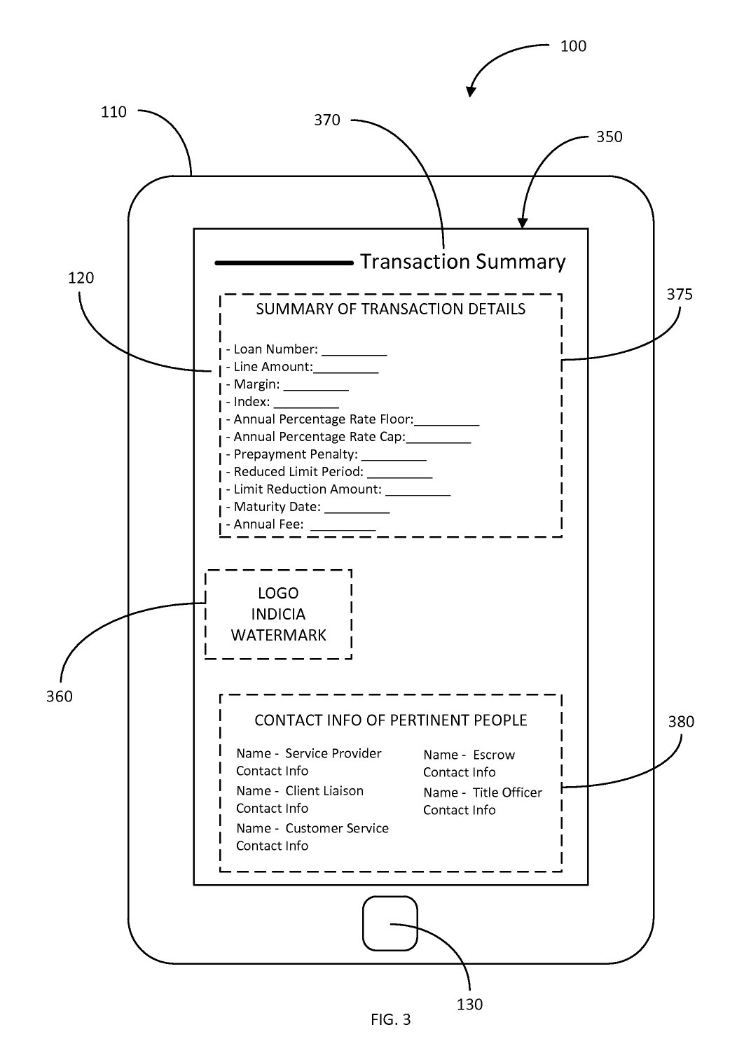

FIG. 3 illustrates a front view of the exemplary electronic closing book 100 displaying an exemplary summary page 350 in accordance with another aspect of the disclosure. The summary page may include relevant information specific to the particular service (e.g., facilitating a transaction) provided to the client by the service provider, as well as contact information of the people and/or entities relevant to the completed services. For example, the client viewing the summary page 350 will be able to identify the key points of the completed services (e.g., the transaction) at a glance.

In particular, the summary page 350 comprises a page heading 370 identifying the page as the summary page (e.g., Transaction Summary). The summary page 350 further comprises a summary of the (e.g., transaction) details section 375. For instance, in this example, the transaction relates to a loan provided to the client, and the details include loan number, line number, margin, and others are provided for quick reference. It shall be understood that the details will depend on the particular service requested by the client.

The summary page 350 further comprises a section 380 for providing contact information of people and/or entities pertinent to the services provided to the client. For instance, the section 380 may include the contact information of the service provider, the client liaison and customer services associated with the service provider. Additionally, the section 380 may include contact information of third parties who had involvement in the services provided to the client. For example, in a real estate transaction, the contact information of the escrow company as well as the title company associated with the real estate transaction may be provided in section 380. As shown, each professional may be identified by title and profession. Thus a client desiring help or information about a particular aspect of the transaction can quickly figure out whom to call for answers. Contact information can include, but is not limited to, business address, office telephone number, cell phone number, email address, and website address. Similar to the previous pages, the summary page 350 may include a watermark 360 of the logo or service mark of the service provider.

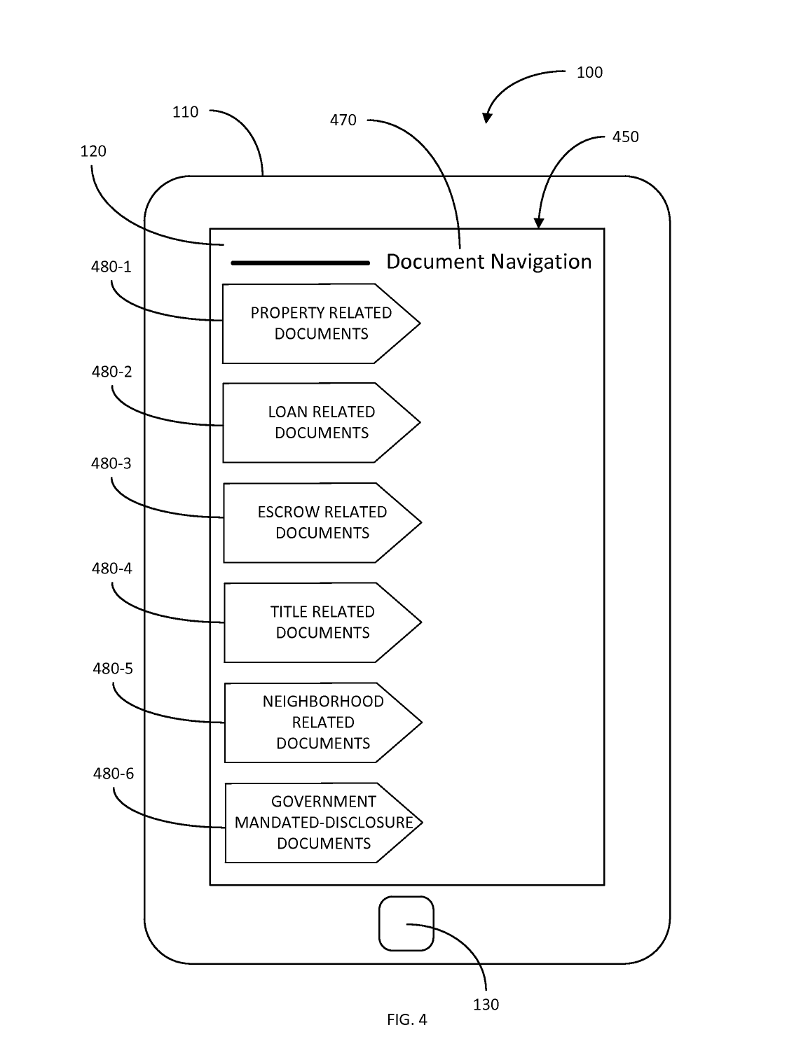

FIG. 4 illustrates a front view of the exemplary electronic closing book 100 displaying an exemplary document navigation page 450 in accordance with another aspect of the disclosure. The document navigation page 450 facilitates the client in locating and accessing a particular document related to the services provided to the client. In particular, the document navigation page 450 comprises a page heading 470 (e.g., “Document Navigation”). Additionally, the document navigation page 450 includes several navigation tools 480-1 to 480-6 for quickly navigating to respective pages displaying relevant documents. Using the control button 130 and/or the touch-sensitive display 120, a user may activate a desired one of those navigation tools 480-1 to 480-6 to go to a corresponding page which displays the relevant documents. Although, in this example, the service provider's watermark is not shown for clarity purposes, it shall be understood that such watermark may be provided in some or all of the pages displayed by the electronic closing book 100.

For example, activating the navigation tool 480-1 of the document navigation page 450 may cause the electronic closing book 100 to display a page indicating all documents relevant to, for example, the property associated with the requested service. Similarly, activating the navigation tool 480-2 may cause the electronic closing book 100 to display a page indicating all documents relevant to, for example, the load associated with the requested services. In a like manner, activating the navigation tool 480-3 may cause the electronic closing book 100 to display a page indicating all documents relevant to, for example, the escrow associated with the requested services. Activating the other navigation tools 480-4 to 480-6 would similarly cause the electronic closing book 100 to display the corresponding pages associated with those tools, respectively.

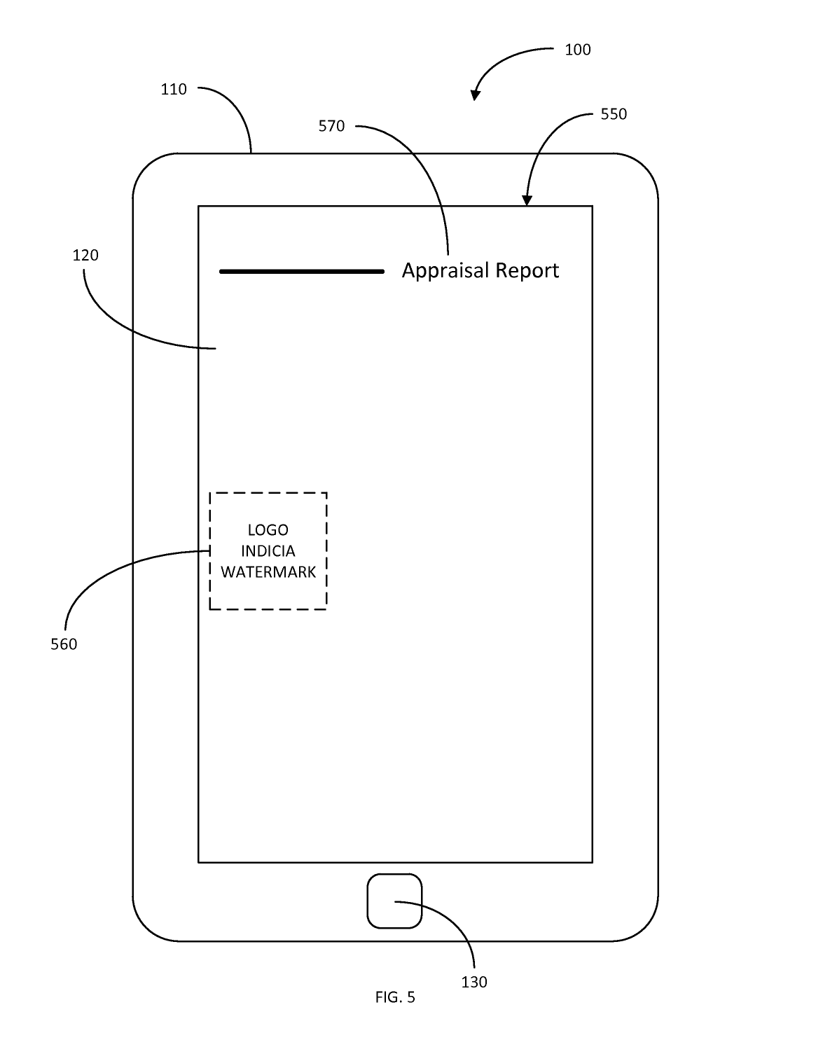

FIG. 5 illustrates a front view of the exemplary electronic closing book 100 displaying an exemplary separation page 550 in accordance with another aspect of the disclosure. The separation page 550 may include a page heading 570 entitled “Appraisal Report” but may be entitled with many other descriptive titles depending on the services provided to the client. The separation page 550 may be placed between important sections of the electronic closing book 100. The separation page 550 signals the reader or client that the end of the previous section has been reached and a new section follows the separation page. The subject of the new section is generally related to the title of the separation page 550. In this example, the separation page 440 also includes a watermark 560 depicting the logo, trademark, or service mark of the service provider, as previously discussed.

Another aspect of the separation page is a bookmark function. By using various linking functions such as bookmarking and hyperlinks each separation page may be marked for rapid navigation. A client concerned with a specific document in the electronic closing book may narrow his search by navigating to the general subject of each separation page.

Other search functions may be included in the electronic closing book. For example, a word search function may be included for quick and specific searches. A user may type in the key word or phrase desired and the electronic closing book would display each instance where the key word or phrase occurs in the document or documents searched.

To support a word search function, documents in the electronic closing book may need to be translated and saved in a format where the text is recognized as text. Many word editing programs are capable of creating documents in a text recognizable format and then translating said document into a more universal digital format such as Portable Document Format (PDF).

Portable Document Format (PDF) is an open standard for document exchange. This file format is used for representing documents in a manner independent of application software, hardware, and operating systems.

However, many legal documents require real pen and ink signatures. In this situation, the signed document may need to be scanned and stored as a digital image file complete with signature.

Storing the originally signed document may require that the documents are saved in a format that supports Optical Character Recognition (OCR). OCR is the mechanical or electronic translation of scanned images of handwritten, typewritten or printed text into machine-encoded text. It is widely used to convert books and documents into electronic files, to computerize a record-keeping system in an office, or to publish text on a website.

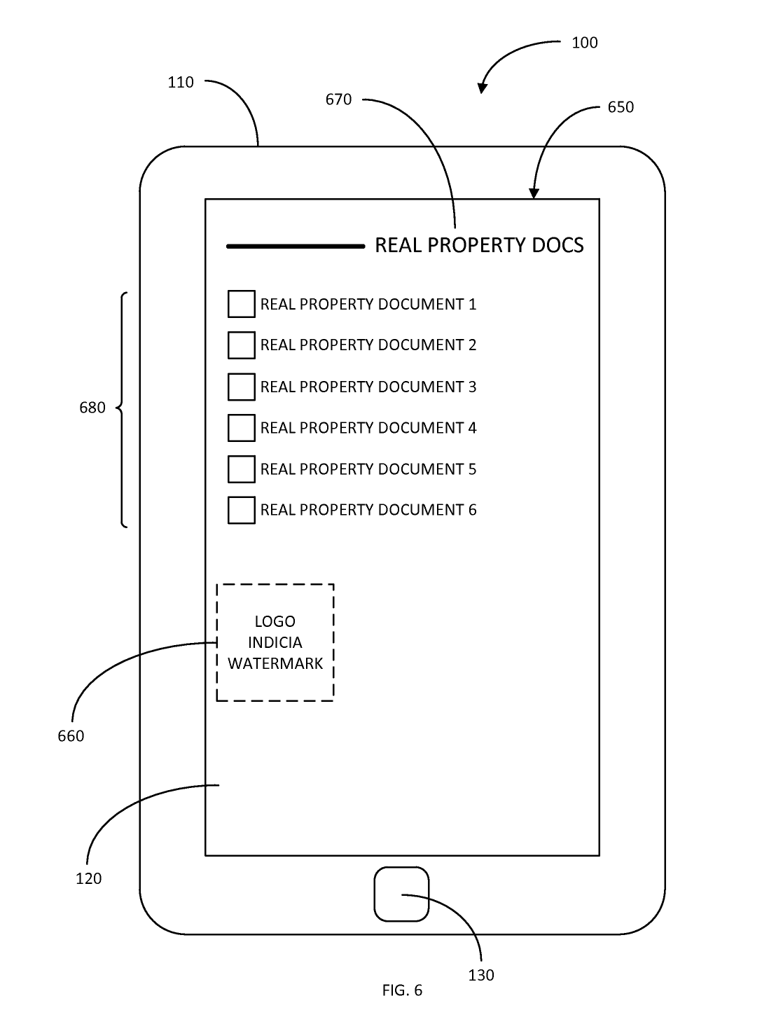

FIG. 6 illustrates a front view of the exemplary electronic closing book 100 displaying an exemplary document access page 650 in accordance with another aspect of the disclosure. As previously discussed with reference to the document navigation page 450, the activation of one of the navigation tools 480-1 to 480-6 may direct the user or client to the document-access page associated with the selected navigation tool. The document access page 650 illustrates the page displayed when the user or client has activated the navigation tool 480-1 pertaining to, for example, property related documents.

In particular, the document access page 650 includes a page heading 670 indicating the subject matter to which the listed documents pertain (e.g., “Real Property Docs”). The document access page 650 also includes a listing 680 of the relevant documents (e.g., Real Property Documents 1-6). Using the control button 130 and/or the touch-sensitive screen 120, the client or user may activate any of the listed documents to access and view the document on the display 120. As shown, the document-access page 650 may also include a watermark 660 depicting the logo, trademark, or service mark of the service provider, as previously discussed. The document-access pages pertaining to the other navigation tools 480-2 to 480-6 may be structured similarly as document-access page 650.

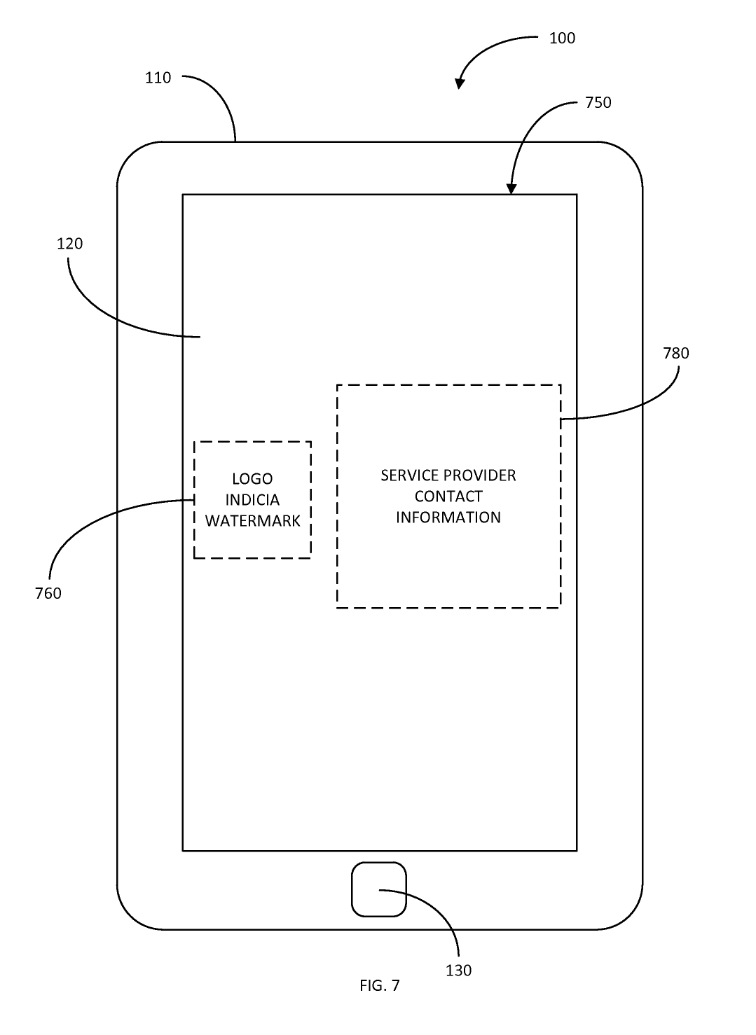

FIG. 7 illustrates a front view of the exemplary electronic closing book 100 displaying an exemplary closing page 750 in accordance with another aspect of the disclosure. The exemplary closing page 750 provides the contact information 780 of the service provider presenting the electronic closing book 100 to the client. In one aspect of the invention, the contact information may contain the name of the principal contact, business address, phone number and email and web address. The closing page 750 is an elegant way to end the presentation of information in the electronic closing book. By ending with information about the principal agent of the transaction, a client will remember the principal agent for future transactions or in case the client may desire to contact the principal agent. As shown, the closing page 750 may also include a watermark 760 depicting the logo, trademark, or service mark of the service provider, as previously discussed.

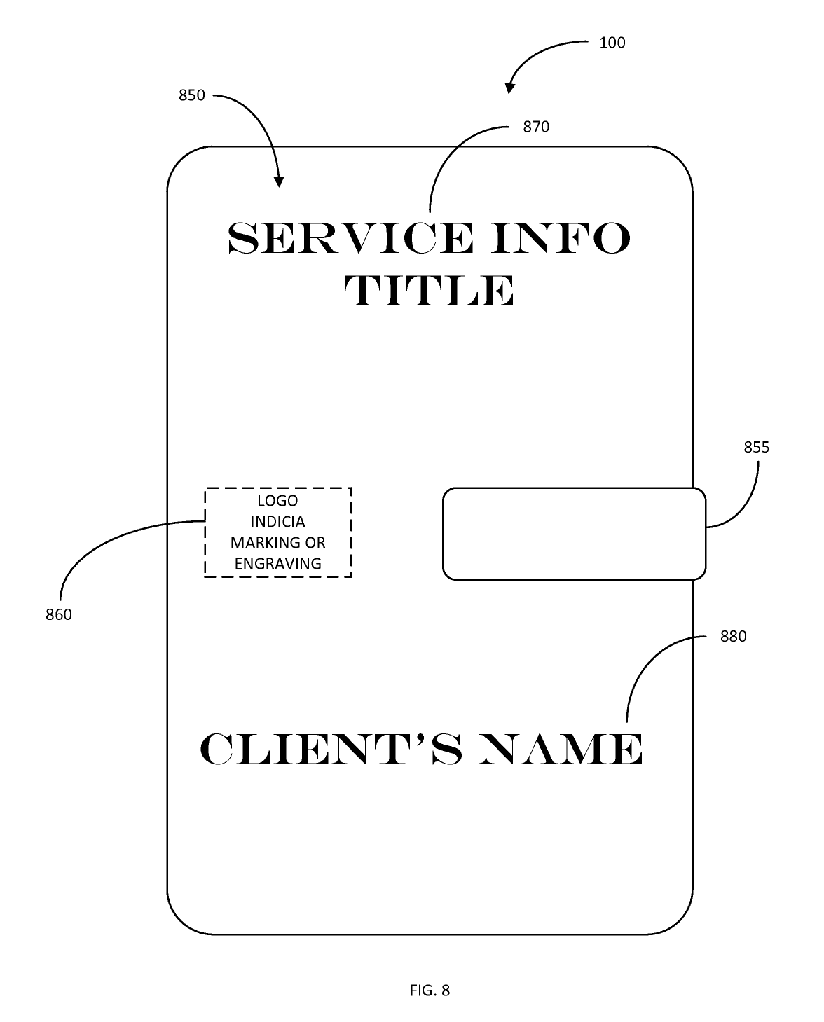

FIG. 8 illustrates a front view of the exemplary electronic closing book 100 including an exemplary personalized cover 850 in accordance with another aspect of the disclosure. The personalized cover 850 may securely receive the electronic closing book 100 and protects the book from possible damage due to handling and usage. The personalized cover 850 may include a strap or opening/closing device 855 to allow the front face of the cover 850 to be opened to allow access to the display 120 and control button 130 of the electronic closing book 100, and to be closed to protect the book when not in use.

The personalized cover 850 may also include a title 870 identifying the subject matter associated with services provided to the client by the service provider. In the example of a sale of a particular property, the title may indicate an identification of the property. Additionally, the personalized cover 850 may also include the client's name 880 to further personalize the electronic closing book 100. The title 870 and client's name 880 may be placed on the cover 850 in an aesthetic manner, using, for example, a stylized font and engraving. Further, the personalized cover 850 may also include an indicia 860 of the logo, trademark, service mark of the service provider, which could also be in a stylized marking and/or engraving.

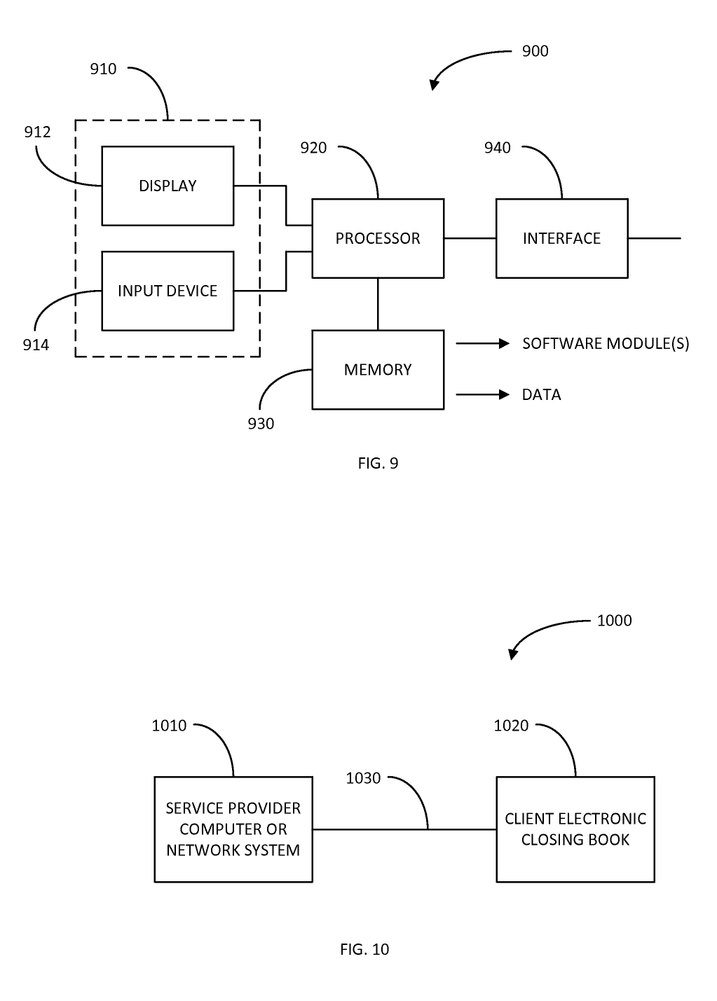

FIG. 9 illustrates a block diagram of an exemplary circuitry 900 used by the electronic closing 100 in accordance with another aspect of the disclosure. The circuitry 900 may comprise a processor 920, a memory 930, an interface 940, and a user input/output (I/O) device 910. The user I/O device 910, in turn, may comprise a display 912 (e.g., such as the display 120 previously discussed), and an input device 914 (e.g., such as the control button 130 previously discussed).

The processor 920 performs the various functions of the electronic closing book under the control of one or more executed software modules accessed from the memory 930. As previously discussed, the various functions performed by the processor 920 includes causing the relevant pages to be displayed on the display 912 based on inputs via the input device 914 and/or the touch-sensitive display 912. The processor 920 may also receive, by way of the interface 940, the various information and documents associated with the services provided to the client by the service provider. The processor 920 may store such information and documents in the memory 930 for subsequent retrieval.

The memory 930 may be any non-transitory computer readable medium, such as random access memory (RAM), read only memory (ROM), and other variants of volatile and non-volatile memories. As previously discussed, the memory 930 stores the software module(s) for controlling the processor 920 in performing its various functions. Additionally, the memory 930 stores data, such as the information and documents related to the services provided to the client by the service provider. The interface 940 is used primary to provide the information and documents to the processor 920 and to the memory 930. Such interface 940 may include a Universal Serial Bus (USB) interface or other type of computer or network interface.

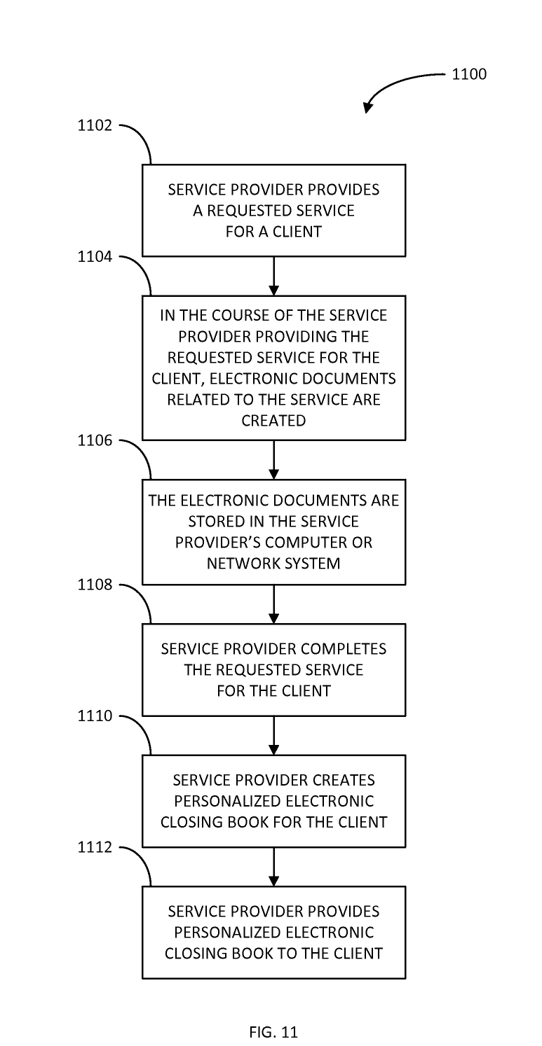

FIG. 10 illustrates a block diagram of an exemplary system 1000 for personalizing an exemplary electronic closing book 1020 in accordance with another aspect of the disclosure. As discussed in more detail below with reference to FIG. 11, a service provider may use a computer or network system 1010 in the course of providing services to a client. In doing so, the service provider may generate and/or receive relevant information and documents from third parties and the client in the course of providing services to the client. The service provider uses the computer or network system 1010 to store the information and documents in an organized manner, as is customary in the service industries.

Once the service provider has completed the requested serviced (e.g., the sale of a property, the purchase of a property, facilitating an investment, etc.), the service provider may transfer the relevant information and documents to a personalized electronic closing book 1020 by way of a communication interface 1030, such as a USB interface. As discussed, the completed electronic closing book 1020 provides a client an easy-to-use depository of the relevant documents and information pertaining to the subject matter for which the service provider rendered services for the client. The following summarizes the process of generating the electronic closing book.

FIG. 11 illustrates a flow diagram of an exemplary method 1100 of forming an exemplary electronic closing book in accordance with another aspect of the disclosure. According to the method 1100, the service provider provides a requested service for a client (block 1102). In the course of providing the requested service to the client, electronic documents and other information are created (block 1104). As previously discussed, such documents and information may originate from the service provider, the client, and/or third parties involved in the services provided to the client.

Continuing with the method 1100, the service provider stores the electronic documents and relevant information in its computer or network system 1010 (block 1106). Once the services are completed (e.g., the transaction has been completed) (block 1108), the service provider connects the personalized electronic closing book 1020 and transfers the relevant electronic documents and information to the book 1020 by way of the communication interface 1030 (block 1110). The step 1110 may include the creation of a personalized cover for the electronic closing book as well as properly placing the electronic closing book in the cover. Once the electronic closing book is complete, the service provider provides the electronic closing book to the client (block 1112).

Although the personalized electronic closing book has been described with reference to the service being related to a real property transaction, it shall be understood that the personalized electronic closing book may be used in connection with any type of services provided to a client, including legal, financial, real estate, taxation, and other types of services.

The invention also relates to an apparatus for performing the operations described herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The processes and displays presented herein are not inherently related to any particular computer, tablet computer, or other apparatus. Various general-purpose systems may be used with programs in accordance with the teachings herein, or it may prove convenient to construct a more specialized apparatus to perform the operations described. The required structure for a variety of these systems will appear from the description below. In addition, the invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

The foregoing discussion merely describes some exemplary embodiments of the present invention. One skilled in the art will readily recognize from such discussion, the accompanying drawings and the claims that various modifications can be made without departing from the spirit and scope of the invention.

1. A method of providing service to a client, comprising:
providing the service to the client by a service provider;
in the course of providing service to the client, generating a plurality of electronic documents related to the service;
storing the plurality of electronic documents in a computer or network system associated with the service provider;
transferring the electronic documents to a personalized electronic closing book; and
providing the personalized electronic closing book to the client
wherein the service provided to the client by the service provider relates to a transaction of a real property; and
further wherein the electronic documents relates to information identifying the real property, information relating to a title of the real property, information relating to a loan associated with a purchase of the real property, information related to escrow associated with the real property, information related to a neighborhood within which the real property is situated, and information related to government-mandated documents.

2. The method of claim 1, wherein providing the personalized electronic closing book is performed near or after completion of the service provided to the client.

3. The method of claim 1, further comprising providing a cover for substantially enclosing the personalized electronic closing book.

4. The method of claim 3, wherein the cover comprises marking or engraving thereupon, wherein the marking or engraving identifies the client, the service provider, and a subject matter related to the service provided to the client.

5. The method of claim 1, wherein the personalized electronic closing book comprises a display and a user input device.

6. The method of claim 5, wherein the personalized electronic closing book is configured to display one or more of the electronic documents in response to a command received by way of the user input device.

7. The method of claim 5, wherein the personalized electronic closing book is configured to display one or more navigation tools to facilitate accessing the electronic documents through the use of one or more commands received by way of the user input device.

8. The method of claim 6, wherein the personalized electronic closing book is configured to display one or more document-access pages in response to activation of one or more navigation tools in response to one or more commands received by way of the user input device.

9. The method of claim 8, wherein each of the document-access pages provides a listing of the electronic documents associated with the corresponding navigation tool.

10. The method of claim 5, wherein the personalized electronic closing book is configured to display a summary of a subject matter associated with the service provided to the client by the service provider.

11. The method of claim 5, wherein the personalized electronic closing book is configured to display a page indicating contact information of the service provider or one or more third parties associated with the service provided to the client by the service provider.

12. The method of claim 5, wherein the personalized electronic closing book is configured to display a foreword page which provides a personal greeting to the client by the service provider.

13. The method of claim 5, wherein the personalized electronic closing book is configured to display one or more pages that includes a watermark of a logo, trademark, service marking or other information that identifies the service provider.

14-20. (canceled)

21. A method of providing service to a client, comprising:
providing the service to the client by a service provider;
in the course of providing service to the client, generating a plurality of electronic documents related to the service;
storing the plurality of electronic documents in a computer or network system associated with the service provider;
transferring the electronic documents to a personalized electronic closing book; and
providing the personalized electronic closing book to the client;
wherein the service provided to the client by the service provider relates to a transaction of a real property;
further wherein the electronic documents relates to information identifying the real property, information relating to a title of the real property, information related to a neighborhood within which the real property is situated, and information related to government-mandated documents.

22. The method of claim 21, wherein the personalized electronic closing book comprises a display and a user input device.

23. The method of claim 22, wherein the personalized electronic closing book is configured to;
display a page indicating contact information of the service provider or one or more third parties associated with the service provided to the client by the service provider;
display a foreword page which provides a personal greeting to the client by the service provider; and
display one or more pages that includes a watermark of a logo, trademark, service marking or other information that identifies the service provider.

24. The method of claim 21, further wherein the electronic documents relates to information relating to a loan associated with a purchase of the real property and information related to escrow associated with the real property.

25. A method of providing service to a client, comprising:
providing the service to the client by a service provider;
in the course of providing service to the client, generating a plurality of electronic documents related to the service;
storing the plurality of electronic documents in a computer or network system associated with the service provider;
transferring the electronic documents to a personalized electronic closing book; and
providing the personalized electronic closing book to the client;
wherein the service provided to the client by the service provider relates to a transaction of a real property;
further wherein the electronic documents relates to information identifying the real property, information relating to a title of the real property, information relating to a loan associated with the real property, information related to escrow associated with the real property, information related to a neighborhood within which the real property is situated, and information related to government-mandated documents.

26. The method of claim 25, wherein the personalized electronic closing book comprises a display and a user input device.

27. The method of claim 26, wherein the personalized electronic closing book is configured to;
display a page indicating contact information of the service provider or one or more third parties associated with the service provided to the client by the service provider;
display a foreword page which provides a personal greeting to the client by the service provider; and
display one or more pages that includes a watermark of a logo, trademark, service marking or other information that identifies the service provider.
